(19) United States
(12) Patent Application Publication
(10) Pub. No.: US 2012/0314244 A1
(43) Pub. Date: Dec. 13, 2012

(54) INFORMATION PROCESSING APPARATUS, METHOD OF CONTROLLING INFORMATION PROCESSING APPARATUS, PROGRAM, AND STORAGE MEDIUM

(75) Inventor: Shukei Kurihara, Yokohama-shi (JP)

(73) Assignee: CANON KABUSHIKI KAISHA, Tokyo (JP)

(21) Appl. No.: 13/119,944

(22) PCT Filed: Jan. 25, 2011
(86) PCT No.: PCT/JP11/51841

§ 371 Date: Mar. 18, 2011

(30) Foreign Application Priority Data
Jan. 29, 2010 (JP) 2010-018854

(51) Int. Cl. G06K 15/02

(52) U.S. Cl. 358/1.15

(57) ABSTRACT

An information processing apparatus that is communicable with a server system including at least one server, and a printer to perform printing. The information processing apparatus includes an accepting unit and a transmission unit. The accepting unit accepts a single instruction, which is input by a user, for instructing printing. The transmission unit transmits a print job to the server system according to the single instruction accepted by the accepting unit, and at the same time transmit an instruction for acquiring print data from the server system, to the printer.

### TECHNICAL FIELD

The present invention relates to an information processing apparatus that is used for causing an image forming apparatus (terminal unit), such as a printer, to performing printing, via a network, a method of controlling the information processing apparatus, a program, and a storage medium, and more particularly to an information processing apparatus that is capable of performing printing efficiently using a server apparatus existing on a network and a method of controlling the information processing apparatus.

### BACKGROUND ART

In recent years, a software usage pattern is becoming popular in which software provided on a network (the Internet, for example) is used without executing an application in each of information processing apparatuses, such as host computers, of respective users. As such a technique for using software on the Internet, so-called cloud computing has come to be known.

In the cloud computing, a cloud generally comprises a plurality of server apparatuses, but each user need not be aware of which server apparatus is executing software such as programs. The cloud computing is characterized by providing various types of services in response to user requests.

In general, in such cloud computing, the server apparatuses (e.g. Web servers) include request accepting servers and processing servers. Each request accepting server accepts a request from a host computer, and the request is executed by the processing servers. Further, the server apparatuses include database (DB) servers that manage various data.

Under a cloud computing environment, the user is not required to install a new server apparatus. Further, it is possible to suppress initial expenditure, such as the purchase of application programs for executing desired processing.

Furthermore, since the cloud provides services, it becomes easier to add a new service, upgrade the versions of the services, etc.

To apply the cloud computing environment to a printing environment, it is only required that the information processing apparatus, such as the host computer, supports only basic functions, and the cloud on the network is caused to execute additional functions.

With this configuration, it is possible to construct the host computer at low costs, and configure a service environment for providing high added values by the versatility and high performance of the cloud.

However, in general, the cloud is often configured not on an intranet but on the Internet. On the other hand, the host computer is connected to a terminal unit (e.g. a printing apparatus) of an image forming apparatus or the like in the intranet.

The intranet suffers from the problem that it is impossible to start communication to a terminal unit within the intranet from the cloud to thereby send image data (print data) from the cloud to the terminal unit, due to restricted use of IP (Internet Protocol) addresses in NAT (Network Address Translation), a firewall, or the like.

To cope with such a problem, there has been proposed a technique, for example, in which print data is stored in the above-mentioned database server and a print instruction is given from an information processing apparatus, such as a host computer, to a terminal unit, such as a printing apparatus (see e.g. PTL (Patent Literature) 1, mentioned hereinafter). In this technique, upon receipt of the print instruction from the information processing apparatus, the terminal unit requests the database server to send the print data.

According to the method disclosed in PTL 1, the request for the print data is performed by communication started from within the intranet to the Internet, it is possible to acquire the print data even if the cloud exists on the Internet.

However, in a printing environment using the cloud according to the method disclosed in PTL 1, the host computer and the terminal unit are exist within the intranet. When this point is considered, to perform printing using additional functions, a printing request is sent from the host computer to the cloud, and to perform printing using only basic functions, it is more efficient to directly send a printing request from the host computer to the terminal unit.

In the method disclosed in PTL 1, however, it is necessary to always send the print data to the database server. In view of these points, the method that the terminal unit simply acquires the print data from the database server is very disadvantageous in efficiency.

### CITATION LIST

### Patent Literature

PTL 1: Japanese Patent Laid-Open Publication No. 2006-146734

### SUMMARY OF INVENTION

### Technical Problem

The present invention provides an information processing apparatus which is capable of performing printing efficiently using a server apparatus existing on a network, such as the Internet, the server apparatus, a method of controlling the information processing apparatus, a program, and a storage medium.

### Solution to Problem

Accordingly, in a first aspect of the present invention, there is provided an information processing apparatus that is communicable with a server system including at least one server, and a printer, comprising an accepting unit configured to accept a single instruction which is input by a user, for instructing printing, and a transmission unit configured to transmit a print job to the server system according to the single instruction accepted by the accepting unit, and at the same time transmit an instruction for acquiring print data from the server system, to the printer.

Accordingly, in a second aspect of the present invention, there is provided a method of controlling an information processing apparatus that is communicable with a server system including at least one server, and a printer, comprising accepting a single instruction which is input by a user, for instructing printing, and transmitting a print job to the server system according to the single instruction accepted by the accepting, and at the same time transmitting an instruction for acquiring print data from the server system, to the printer.

Accordingly, in a third aspect of the present invention, there is provided a computer-executable program for causing a computer to execute a method of controlling an information processing apparatus that is communicable with a server system including at least one server, and a printer, wherein the method comprises accepting a single instruction which is input by a user, for instructing printing, and transmitting a print job to the server system according to the single instruction accepted by the accepting, and at the same time transmitting an instruction for acquiring print data from the server system, to the printer.

Accordingly, in a fourth aspect of the present invention, there is provided a non-transitory computer-readable storage medium storing the computer-executable program.

### Advantageous Effects of Invention

As described above, according to the present invention, even when image processing functions for generating print data are caused to be executed by the server apparatus outside the intranet, it is possible for the printing apparatus to receive and process a print job. Further, when it is not necessary to cause the server apparatus outside the intranet to execute the image processing functions, it is possible to perform printing efficiently since the print job is directly sent from the information processing apparatus to the printing apparatus, for causing a print process to be executed thereby.

The features and advantages of the invention will become more apparent from the following detailed description taken in conjunction with the accompanying drawings.

### BRIEF DESCRIPTION OF DRAWINGS

FIG. 1 is a block diagram of a printing system according to an embodiment of the present invention.

FIG. 2 is a block diagram of the hardware configuration of a cloud appearing in FIG. 1.

FIG. 3 is a block diagram of the software configuration of the cloud appearing in FIG. 1.

FIG. 4 is a block diagram of the hardware configuration of a host computer and a printer appearing in FIG. 1.

FIG. 5 is a block diagram of the software configuration of the host computer and the printer appearing in FIG. 1.

FIG. 6 is a flowchart of a device setting process for setting the printer appearing in FIG. 1.

FIG. 7 is a diagram showing an example of a network configuration display screen displayed on a CRT appearing in FIG. 4.

FIG. 8 is a flowchart of a device registration process executed by the cloud appearing in FIG. 1.

FIG. 9 is a diagram showing an example of user data (registration information) registered in the cloud appearing in FIG. 1.

FIG. 10 is a flowchart of a driver installation process executed by an installer which operates on the host computer appearing in FIG. 1.

FIG. 11 is a diagram showing an example of a cloud ID input screen displayed on the CRT appearing in FIG. 4.

FIG. 12 is a diagram showing an example of a printer list screen displayed on the CRT appearing in FIG. 4.

FIG. 13A is a sequence diagram showing a flow of a process between the host computer, the cloud, and the printer appearing in FIG. 1.

FIG. 13B is a continuation of FIG. 13B.

FIG. 14 is a flowchart of a print process executed by the printer driver appearing in FIG. 5.

FIG. 15A is a diagram showing a basic setting tab screen of a user interface displayed on the CRT appearing in FIG. 4.

FIG. 15B is a diagram showing an extension setting tab screen of the user interface.

FIG. 16A is a flowchart of a print process executed by the cloud appearing in FIG. 1.

FIG. 16B is a continuation of FIG. 16A.

FIG. 17A is a flowchart of a print process executed by the printer (device) appearing in FIG. 1.

FIG. 17B is a continuation of FIG. 17A.

### DESCRIPTION OF EMBODIMENTS

Hereinafter, a description will be given of an example of an information processing apparatus according to an embodiment of the present invention and a printing system using the information processing apparatus. In the following description, the printing system is assumed to perform printing using a cloud (one or a plurality of server apparatuses) under a cloud computing environment.

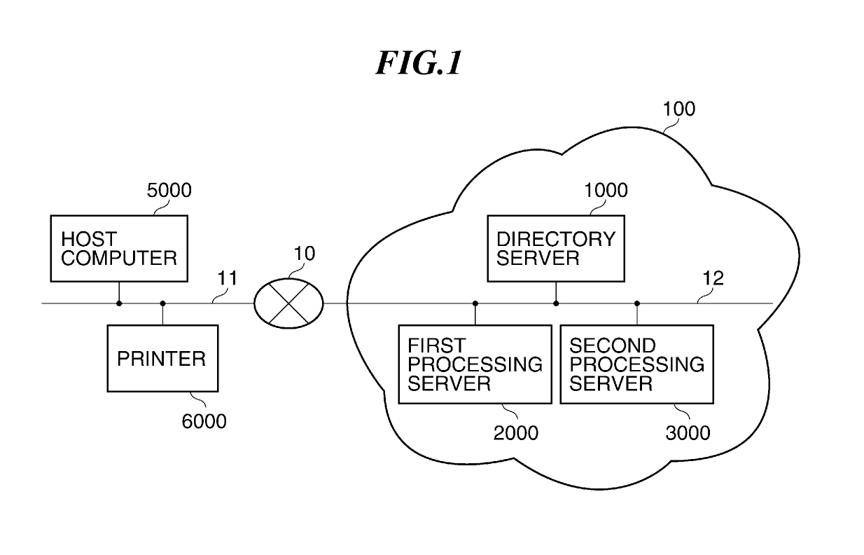

FIG. 1 is a block diagram of the printing system according to the embodiment of the present invention.

Referring to FIG. 1, the illustrated printing system includes a host computer 5000 as an information processing apparatus, and a printer 6000 as a terminal device. The host computer 5000 and the printer 6000 are connected to each other by a network 11 (e.g. an intranet). Although in the illustrated example, only one printer 6000 is shown, there may exist a plurality of printers 6000.

The network 11 is connected to a network 0 (e.g. the Internet), and the cloud 100 exists on the Internet 10. Although in the illustrated example, only one cloud 100 is shown, a case can also be envisaged where a plurality of clouds exist on the Internet 10.

In the illustrated example, the cloud 100 includes a directory server 1000, a first processing server 2000, and a second processing server 3000 (although not shown, the cloud 100 includes a billing server as well). These directory server 1000, first processing server 2000, and second processing server 3000 are connected to each other by a network 12.

In this example, the directory server 1000 accepts a job (print job) from the host computer 5000 via the network 10. The first and second processing servers 2000 and 3000 perform processing according to settings (job configuration) designated by the directory server 1000 and the print job.

Although in the illustrated example, the cloud 100 includes only the first and second processing servers 2000 and 3000, it is possible to freely increase the number of processing servers according to the number of functions provided by the cloud 100 and the like.

As described above, the host computer 5000 and the printer 6000 under a user environment and the cloud 100 are connected via the Internet 10 to thereby form the printing system.

In the illustrated printing system, functions which are not supported by the printer 6000 are realized by using the cloud 100. For example, it is assumed that although the printer 6000 does not support so-called copy-forgery-inhibited pattern processing, the cloud 100 provides a service of the copy-forgery-inhibited pattern processing. In this case, the print job is sent from the host computer 5000 to the cloud 100. The cloud 100 executes the copy-forgery-inhibited pattern processing according to the print job, and then sends data obtained by the copy-forgery-inhibited pattern processing (i.e. print data) to the printer 6000 via the Internet 10, whereafter printing of the data is executed by the printer 6000.

However, as described above, the cloud 100 is constructed on the Internet 10, not on the intranet. This brings about the problem as described hereinabove. Now, a description will be given of a system usage pattern in which the cloud 100 is caused to execute the copy-forgery-inhibited pattern processing as one of extension functions and the printer 6000 delivers prints, by way of example.

In the illustrated example, a print job generated by the host computer 5000 is configured to use an additional function, the host computer 5000 sends the print job to the cloud 100 via the Internet 10. Then, the host computer 5000 notifies the printer 6000 via the network 11 that the print job has been generated.

Upon receipt of the notification, the printer 6000 requests the cloud 100 to send print data, using the Internet 10. In response to the request of the print data, the cloud 100 sends the print data to the printer 6000. Then, the printer 6000 performs printing according to the print data.

On the other hand, when the print job generated by the host computer 5000 is configured to use only basic functions, the host computer 5000 sends the print job to the printer 6000 via the network 11. The printer 6000 performs printing according to the received print job.

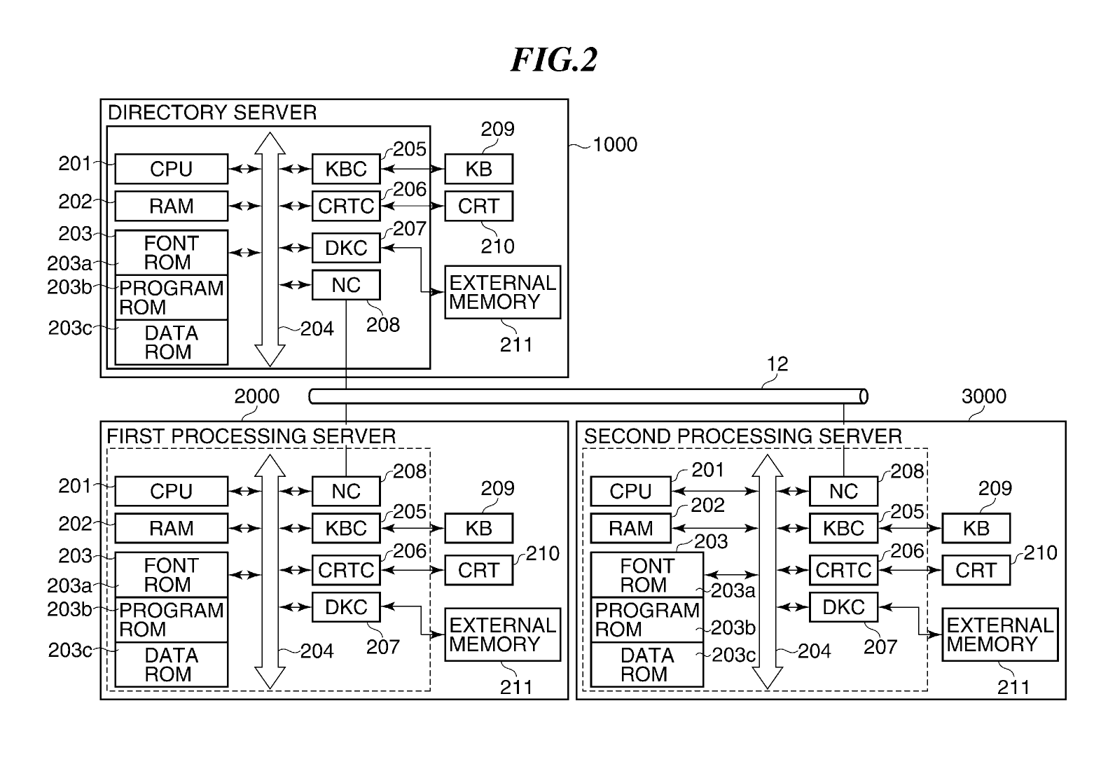

FIG. 2 is a block diagram of the hardware configuration of the cloud (one or a plurality of server apparatuses) 100 appearing in FIG. 1.

Referring to FIG. 2, the directory server 1000 includes a CPU (Central Processing Unit) 201, a RAM (Random Access Memory) 202, and a ROM (Read Only Memory) 203. The ROM 203 comprises a font ROM 203a, a program ROM 203b, and a data ROM 203c.

The directory server 100 further includes a keyboard controller (KBC) 205, a CRT controller (CRTC) 206, a disk controller (DKC) 207, and a network controller (NC) 208. These component elements are connected to each other via a system bus 204.

The keyboard controller 205 controls key input by a keyboard (KB) 209 and a pointing device (not shown). The CRT controller 206 controls display by a CRT display (CRT) 210. The disk controller 207 controls accesses to an external memory 211, such as a hard disk (HD) or a floppy (registered trademark) disk (FD), which stores a boot program, various applications, user files, edited files, etc.

The network controller 208 is connected to the first and second processing servers 2000 and 3000 and a billing server (not shown) via the network 12. The network controller 208 controls communication with the first and second processing servers 2000 and 3000 and the billing server.

The CPU 201 operates according to a control program (operating system (OS)) stored in the program ROM 203b or the external memory 211. The CPU 201 executes a job assigning process according to a job accepting program and the like stored in the program ROM 203b or the external memory 211. That is, the CPU 201 executes a process for assigning a received job to one of the first and second processing servers 2000 and 3000 and the billing server.

When the job assigning process or the like is performed, various data used in the job assigning process are stored in the RAM 202 or the external memory 211. It should be noted that the RAM 202 is used as a main memory, a work area, etc. for the CPU 201.

Further, the CPU 201 executes centralized control of all the component elements connected to the system bus 204.

The hardware configuration of the first and second processing servers 2000 and 3000 is the same as that of the directory server 1000, and hence component elements identical to those of the directory server 1000 are denoted by identical reference numerals. It should be noted that in each of the first and second processing servers 2000 and 3000, the program ROM 203b or the external memory 211 stores a job processing program.

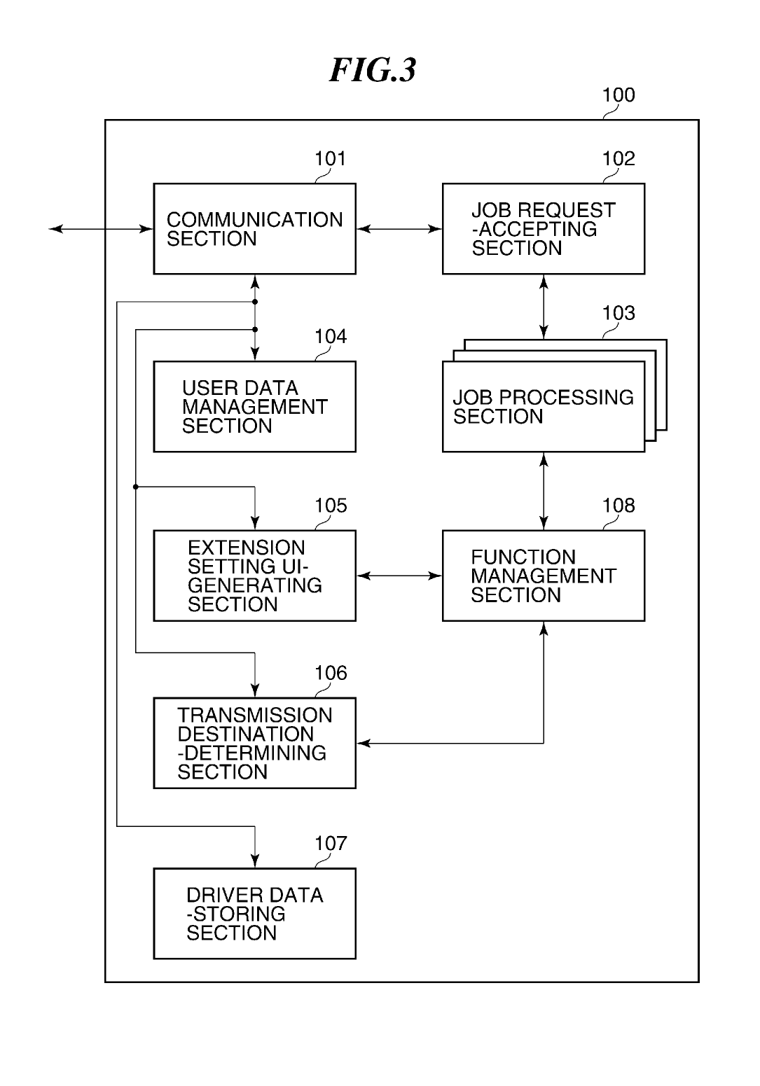

FIG. 3 is a block diagram of the software configuration of the cloud 100 appearing in FIG. 1. FIG. 3 shows the functions of the software. These functions are realized by the CPU 201 of the directory server 1000 and the first and second processing servers 2000 and 3000. The following description is given of a case where the directory server 1000 and the first and second processing servers 2000 and 3000 integrally operate as the cloud 100.

Referring to FIG. 3, the software that operates on the cloud 100 includes a communication section 101, a job request-accepting section 102, a plurality of job processing sections 103, a user data management section 104, an extension setting user interface-generating section 105, a transmission destination-determining section 106, a driver data-storing section 107, and a function management section 108. The plurality of job processing sections 103 are provided in association with kinds of processes of print jobs, respectively.

The communication section 101 receives a print job from the printer 6000, and performs data transmission within the cloud 100. The job request-accepting section 102 accepts the print job received by the communication section 101 and then analyzes information on processing indicated by the print job (print job processing information). The job request-accepting section 102 sends the print job to one of the job processing sections 103, which is associated with the print job processing information, according to the analysis result.

Further, when the job request-accepting section 102 receives a printout completion notification indicating that printout has been completed by the printer 6000, from the communication section 101, as described hereinafter, it sends the printout completion notification to the associated job processing section 103.

The job processing sections 103 executes print job processing according to the print job processing information, for generating print data. Then, the job processing section 103 sends the print data to the communication section 101 via the job request-accepting section 102.

The user data management section 104 manages a list of the printers 6000 registered for using the cloud 100, on a contract-by-contract basis. In response to an extension setting user interface information request sent from the host computer 5000, the extension setting user interface-generating section 105 acquires latest function information from the function management section 108 and generates extension setting user interface information.

The transmission destination-determining section 106 determines whether or not a print process is to be executed by the cloud 100, according to print job setting information received from the host computer 5000. If it is determined that the print process is to be executed by the cloud 100, the transmission destination-determining section 106 determines the cloud 100 as a transmission destination. On the other hand, if it is determined that the print process is not to be performed by the cloud 100, the transmission destination-determining section 106 determines the printer 6000 as the transmission destination.

The driver data-storing section 107 stores modules to be installed in the host computer 5000. The driver data-storing section 107 sends a module via the communication section 101 according to a request from the host computer 5000. The function management section 108 communicates with the job processing sections 103 to thereby manage a list of functions provided in the cloud 100 and the versions of the functions.

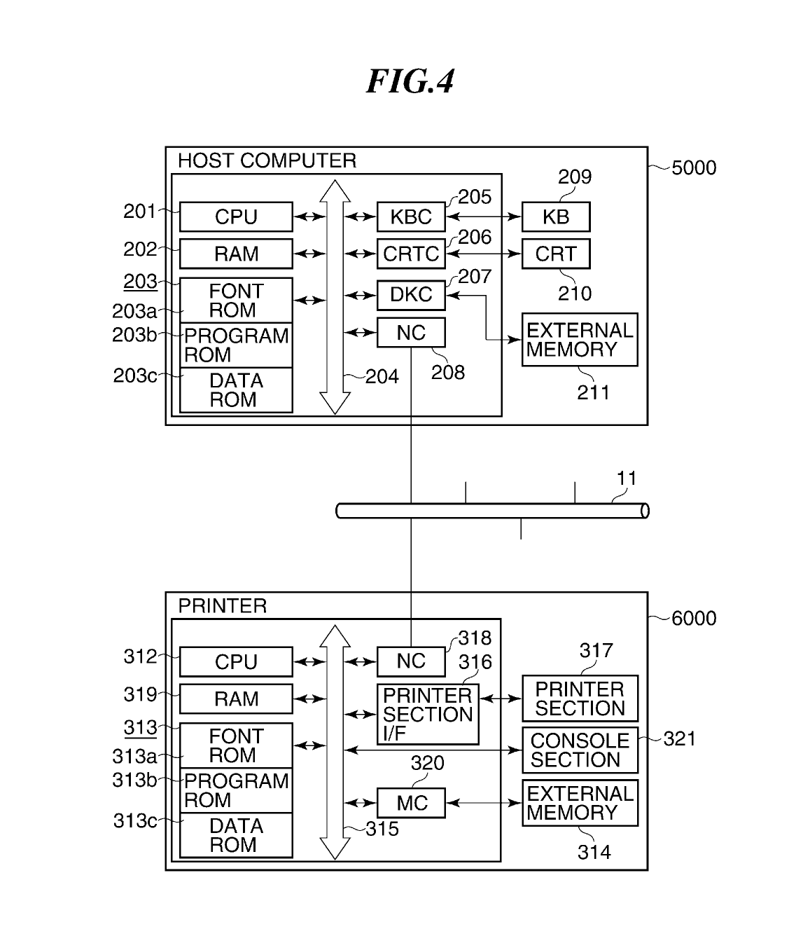

FIG. 4 is a block diagram of the hardware configuration of the host computer 5000 and the printer 6000 appearing in FIG. 1. Referring to FIG. 4, the host computer 5000 has the same hardware configuration as that of the directory server 1000. In the host computer 5000 appearing in FIG. 4, hardware elements identical to the hardware elements appearing in FIG. 2 are denoted by identical reference numerals.

In the host computer 5000 appearing in FIG. 4, the program ROM 203b or the external memory 211 stores application programs, a printer control command generation program, and so forth. The CPU 201 executes a document data generation process for generating document data containing graphics, images, text, and tables (including spreadsheets) in a mixed manner, based on these programs. Further, the CPU 201 executes a print job generation process concerning document data.

Further, in the host computer 5000, the program ROM 203b or the external memory 211 stores the operating system (OS) as a control program for the CPU 201, etc. Further, the font ROM 203a or the external memory 211 stores font data and the like, which are used during the print job generation process executed on document data.

It should be noted that the RAM 202 or the external memory 211 stores various data for use during the document data generation process and the print job generation process and so forth.

In the host computer 5000, the network controller 208 is connected to the printer 6000 and the cloud 100 via the network 11 (FIG. 1), for controlling communication with the printer 6000 and the cloud 100.

It should be noted that the CPU 201 carries out processing for rasterizing an outline font e.g. into a display information RAM secured in the RAM 202. This enables WYSIWYG (What You See Is What You Get) on the CRT 210.

Further, the CPU 201 opens registered windows based on commands indicated by a mouse cursor (not shown) or the like displayed on the CRT 210, and executes various types of data processing. To execute a print process, the user can open a window for configuring print settings to configure the printer 6000 for printing (user input).

In FIG. 4, the printer 6000 includes a CPU 312, a ROM 313, a printer section interface 316, an network controller 318, a RAM 319, and a memory controller (MC) 320 as the hardware configuration. The ROM 313 comprises a font ROM 313a, a program ROM 313b, and a data ROM 313c.

The network controller 318 is connected to the network 11. Further, a printer section (printer engine) 317 is connected to the printer section interface 316, and an external memory 314 is connected to the MC 320. The component elements of the printer 6000 are connected to each other by a system bus 315. Furthermore, a console section 321 is connected to the system bus 315.

The CPU 312 outputs image signals (image data) as output information to the printer section 317 based on a control program, etc. stored in the program ROM 313b or the external memory 314. Further, the font ROM 313a stores font data, etc. for use in generating image data.

The data ROM 313c has various data and the like stored therein for being used on the host computer 5000. The external memory 314 is also capable of storing print data of a user.

The CPU 312 is capable of communicating with the host computer 5000 and the cloud 100 via the network controller 318. For example, the CPU 312 can notify the host computer 5000 and the cloud 100 of various data, etc. stored in the printer 6000. The RAM 319 is used as a main memory, a work area, etc. for the CPU 312.

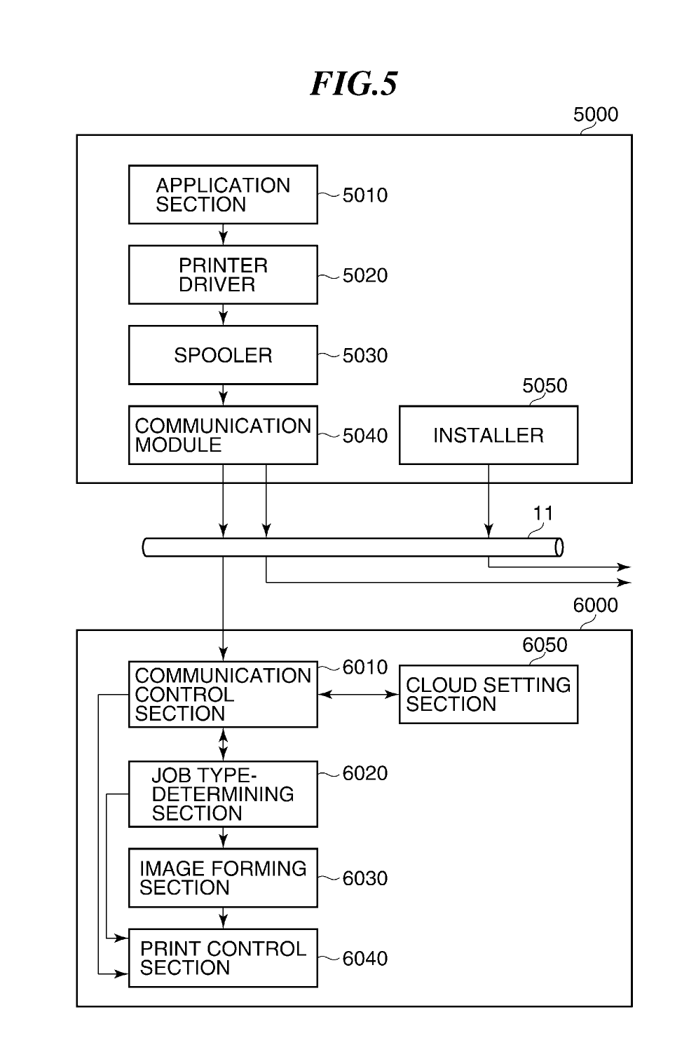

FIG. 5 is a block diagram of the software configuration of the host computer 5000 and the printer 6000 appearing in FIG. 1. FIG. 5 shows functions of the software provided in the host computer 5000 and the printer 6000. These functions are realized by the CPU 201 of the host computer 5000 and the CPU 312 of the printer 6000.

Referring to FIG. 5, the software that operates on the host computer 5000 includes an application section 5010, a printer driver 5020, a spooler 5030, a communication module 5040, and an installer 5050.

Further, the software that operates on the printer 6000 includes a communication control section 6010, a job type-determining section 6020, an image forming section 6030, a print control section 6040, and a cloud setting section 6050.

In the host computer 5000, the installer 5050 acquires a module to be installed, from the cloud 100, and installs the module in the host computer 5000. Drawing data requested by the application section 5010 for being printed is given to the printer driver 5020. The printer driver 5020 generates a print job according to the drawing data.

This print job is spooled in the spooler 5030. The spooled print job is given to the communication module 5040. The communication module 5040 sends print job setting information of the print job to the cloud 100 to thereby acquire transmission destination information, as described hereinafter.

When the transmission destination information designates the cloud 100 as a transmission destination, the communication module 5040 sends the print job to the cloud 100. On the other hand, when the transmission destination information designates a device as a transmission destination, the communication module 5040 sends the print job to the printer 6000.

In the printer 6000, the cloud setting section 6050 performs configuration concerning the cloud 100 to generate registration information. The registration information is sent to the cloud 100 via the communication control section 6010. Upon receipt of the print job from the host computer 5000, the communication control section 6010 gives this print job to the job type-determining section 6020.

The job type-determining section 6020 determines the job type of the print job according to the print job. For example, if it is determined that the job type of the print job is one in which the printer 6000 alone uses the cloud 100, the job type-determining section 6020 uses the communication control section 6010 to request the cloud 100 to send print data.

In requesting the cloud 100 to send the print data, polling is performed by the communication control section 6010. In response to the request of the print data, the print data is sent from the cloud 100 to the printer 6000.

On the other hand, if it is determined that the job type of the print job is one in which the print job can be executed by the printer 6000 alone, the job type-determining section 6020 gives the print job to the image forming section 6030. The image forming section 6030 generates image data (also referred to as “print data”) based on the print job. Then, the image forming section 6030 sends the print data to the print control section 6040, and the print control section 6040 executes printout processing.

By the way, when the printer 6000 receives the print data from the cloud 100 via the communication control section 6010, this print data is sent from the communication control section 6010 to the job type-determining section 6020. When it is determined that the print data is sent from the cloud 100, the job type-determining section 6020 sends the print data to the print control section 6040.

The print control section 6040 carries out the printout processing according to the print data. Upon completion of the printout processing, the print control section 6040 notifies the cloud 100 of completion of the printout processing on a page-by-page basis via the communication control section 6010.

Here, a description will be given of a preliminary process performed before executing printing.

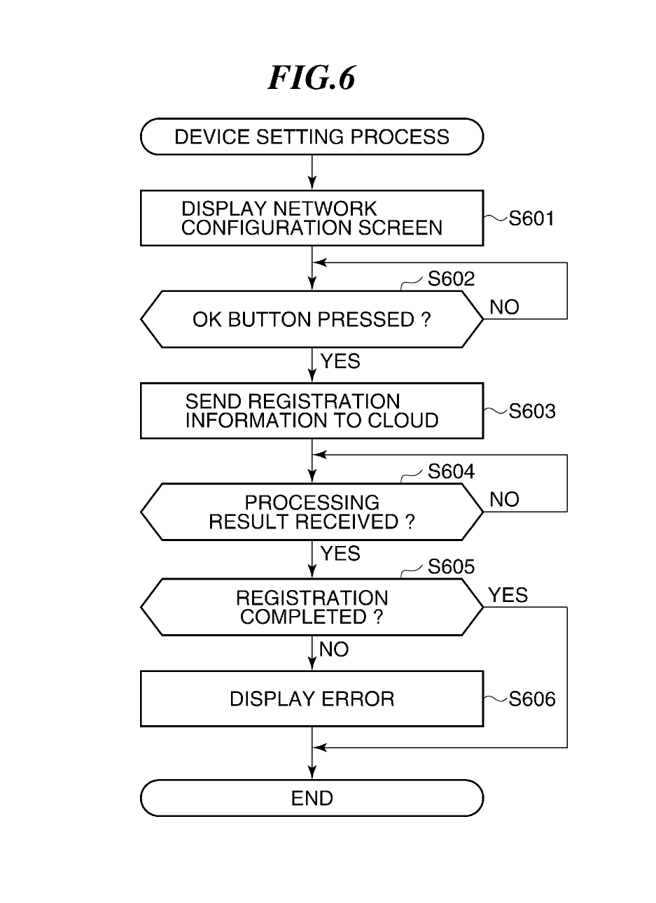

FIG. 6 is a flowchart of a device setting process for setting the printer (also referred to as the “device”) 6000 appearing in FIG. 1. When the printer 6000 is started, the CPU 201 displays a network configuration screen on the CRT 210 of the host computer 5000 (FIG. 4), for example.

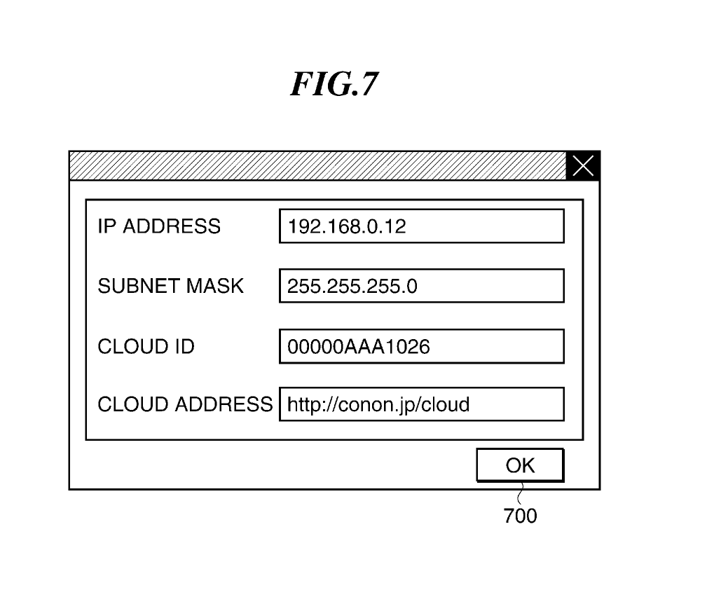

FIG. 7 shows an example of a network configuration display screen displayed on the CRT 210 appearing in FIG. 4. As shown in FIG. 7, the network configuration display screen displays an IP address, a subnet mask, a cloud ID (identification information), a cloud address, and an OK button 700.

Referring to FIGS. 4, 6, and 7, as described above, when the printer 6000 is started, the CPU 201 of the host computer 5000 displays the network configuration screen on the display of the CRT 210 (step S601). Then, the CPU 201 monitors whether or not the OK button 700 has been pressed (step S602). The user performs configuration of a network for using the cloud 100 from the network configuration screen (user input).

More specifically, the user inputs the IP address, the subnet mask, and the cloud ID as network configuration information for using the cloud 100, on the network configuration screen. After setting the network configuration information, if the user presses the OK button 700 on the network configuration screen (YES to the step S602), the CPU 201 of the host computer 5000 stores the network configuration information e.g. in the external memory 211. Then, registration information including the network configuration information is sent from the printer 6000 to the cloud 100 (step S603). If the OK button 700 has not been pressed (NO to the step S602), the CPU 201 is on standby.

The above-described registration information includes the name and the type of the device, the IP address, the subnet mask, and the device ID.

Subsequently, the CPU 201 of the host computer 5000 determines whether or not a notification of the result of registration processing sent from the cloud 100 has been received by way of the printer 600 (step S604). Unless the notification of the registration processing result has been received (NO to the step S604), the CPU 201 waits until it receives the notification of the registration processing result.

On the other hand, if the notification of the registration processing result has been received (YES to the step S604), the CPU 201 of the host computer 5000 determines whether or not the registration processing result indicates completion of registration (step S605). If the registration processing result indicates the completion of the registration (YES to the step S605), the CPU 201 terminates the device setting process.

If the registration processing result does not indicate the completion of the registration (NO to the step S605), the CPU 201 of the host computer 5000 displays an error message on the CRT 210 (step S606), followed by terminating the device setting process.

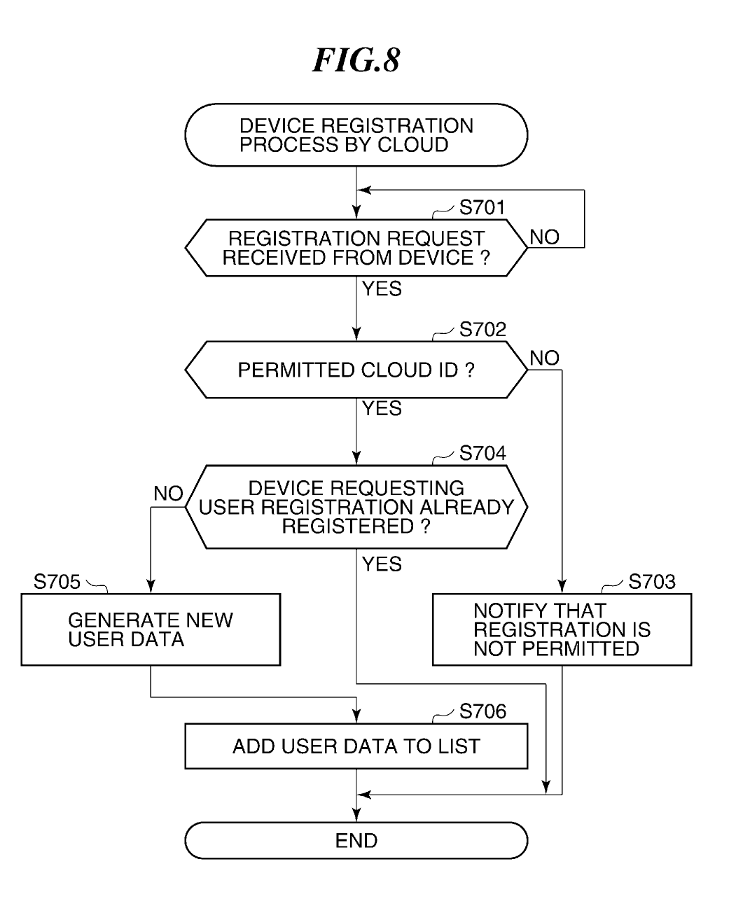

FIG. 8 is a flowchart of a device registration process executed by the cloud 100 appearing in FIG. 1.

Referring to FIGS. 2 and 8, in the directory server 1000, the CPU 201 determines whether or not there has been received a registration request from any device (step S701). If no registration request has been received (NO to the step S701), the CPU 201 waits until it receives a registration request.

On the other hand, if a registration request has been received (YES to the step S701), the CPU 201 of the directory server 1000 determines based on the registration information of the registration request whether or not the cloud ID (identification information) set forth therein is a permitted cloud ID (step S702). More specifically, the CPU 201 determines whether or not the cloud ID set forth as an item of registration information in the registration request is an cloud ID representative of a cloud permitted to be used by a device that has made access thereto. It should be noted that the permitted cloud IDs are set in advance and stored in the external memory 211 or the like of the directory server 1000.

If the cloud ID in the registration request has not been permitted (NO to the step S702), the CPU 201 of the directory server 1000 notifies the printer 6000 that the registration of the printer 6000 is not permitted (step S703). Then, the CPU 201 terminates the device registration process.

If the cloud ID in the registration request is a permitted cloud ID (YES to the step S702), the CPU 201 of the directory server 1000 determines whether or not the device requesting user registration thereof as a user of the cloud having the cloud ID is a registered device (step S704).

If the device requesting the user registration is not a registered device (NO to the step S704), the CPU 201 of the directory server 1000 generates new user data (step S705).

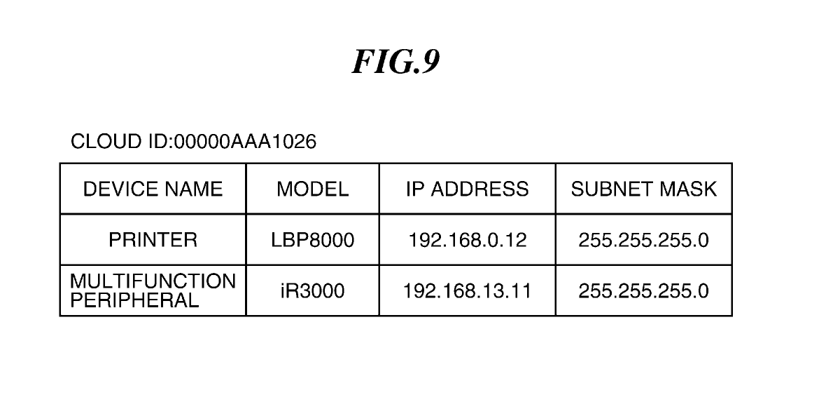

FIG. 9 is a diagram showing an example of the user data (registration information) registered in the cloud 100 appearing in FIG. 1. As shown in FIG. 9, the user data (registration information) has a column of devices names indicative of respective types of devices (e.g. printers, multifunction peripherals), and each device name is registered in association with a model, an IP address, and a subnet mask set forth in associated boxes of respective columns. The user data is stored in association with the cloud ID.

After that, the CPU 201 of the directory server 1000 adds the new user data to a device list (step S706), followed by terminating the device registration process. It should be noted that the above-described device list is stored e.g. in the external memory 211 of the directory server 1000.

On the other hand, if the device requesting the user registration has already been registered (YES to the step S704), the CPU 201 immediately terminates the device registration process.

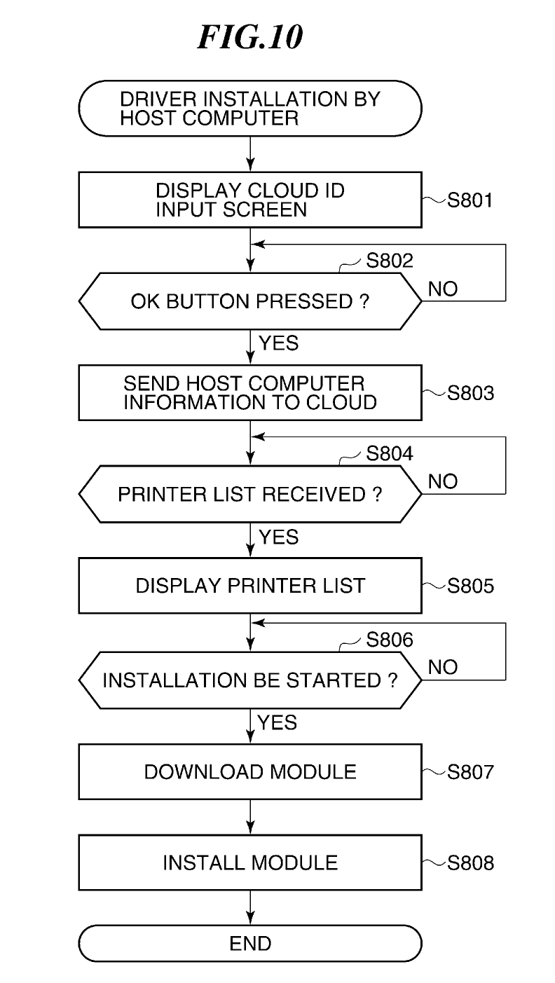

FIG. 10 is a flowchart of a driver installation process executed by an installer 5000 which operates on the host computer 5000 appearing in FIG. 1.

Referring to FIGS. 5 and 10, in the host computer 5000, when the installer 5050 is started on the CPU 201, the CPU 201 of the host computer 5000 displays a cloud ID input screen on the CRT 210 of the host computer 5000 (step S801).

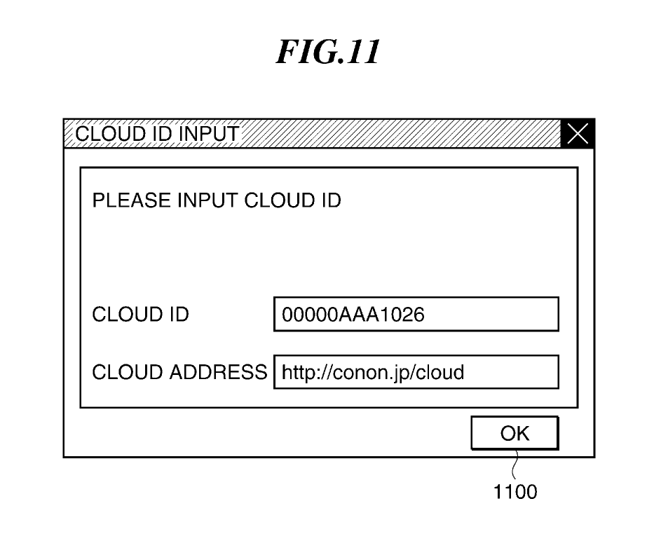

FIG. 11 is a diagram showing an example of the cloud ID input screen displayed on the CRT 210 of the host computer 5000 appearing in FIG. 4. As shown in FIG. 11, on the cloud ID display screen, there are displayed a title of “CLOUD ID INPUT” and a message of “PLEASE INPUT CLOUD ID”.

Further, a cloud ID column and a cloud address column are displayed on the cloud ID input screen. An OK button 1100 is also displayed at the bottom of the cloud ID display screen.

After displaying the above-mentioned cloud ID input screen, the CPU 201 of the host computer 5000 monitors whether or not the OK button 1100 has been pressed (step S802). The user enters a cloud ID, following the message of the cloud ID input screen. When the user enters the cloud ID, and then presses the OK button 1100 on the cloud ID input screen (YES to the step S802), the CPU 201 sends the cloud ID and host computer information (the IP address and the subnet mask) to the cloud 100 (step S803). It should be noted that if the OK button 1100 has not been pressed (NO to the step S802), the CPU 201 waits until the OK button 1100 is pressed.

Subsequently, the CPU 201 of the host computer 5000 determines whether or not a list of installable printers (printer list) has been received from the cloud 100 (step S804). If the printer list has been received (YES to the step S804), the CPU 201 displays the printer list on the CRT 210 (step S805). If the printer list has not been received (NO to the step S804), the CPU 201 waits until it receives the printer list.

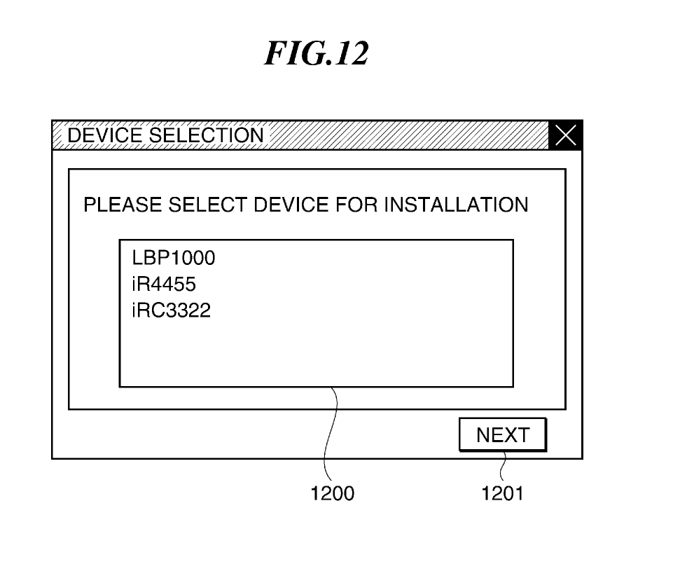

FIG. 12 is a diagram showing an example of the printer list screen displayed on the CRT 210 of the host computer 5000 appearing in FIG. 4. As shown in FIG. 12, on the printer list screen, there are displayed a title of “DEVICE SELECTION” and a message of “PLEASE SELECT DEVICE FOR INSTALLATION”. Further, a device list 1200 is displayed on the printer list screen, and a “NEXT” button 1201 is displayed at the bottom of the same.

After that, the CPU 201 of the host computer 5000 determines whether or not installation of a selected device is to be started (step S806). More specifically, when the “NEXT” button is pressed after selecting a device where a driver is to be installed, on the printer list screen, the CPU 201 determines whether or not an OK button (not shown) has been pressed on a check screen (not shown) displayed next.

If the OK button has been pressed (YES to the step S806), the CPU 201 of the host computer 5000 determines that the start of the installation has been instructed, and downloads a module for a model selected on the printer list screen from the cloud 100 (step S807). Then, the CPU 201 installs the downloaded module (driver) in the host computer 5000 (step S808), followed by terminating the driver installation process. It should be noted that if the OK button 1100 has not been pressed (NO to the step S806), the CPU 201 waits until the OK button 1100 is pressed.

Next, a description will be given of processes executed for printing. To begin with, a flow of processing executed between the host computer 5000, the cloud 100, and the printer (device) 6000 shown in FIG. 1 will be described.

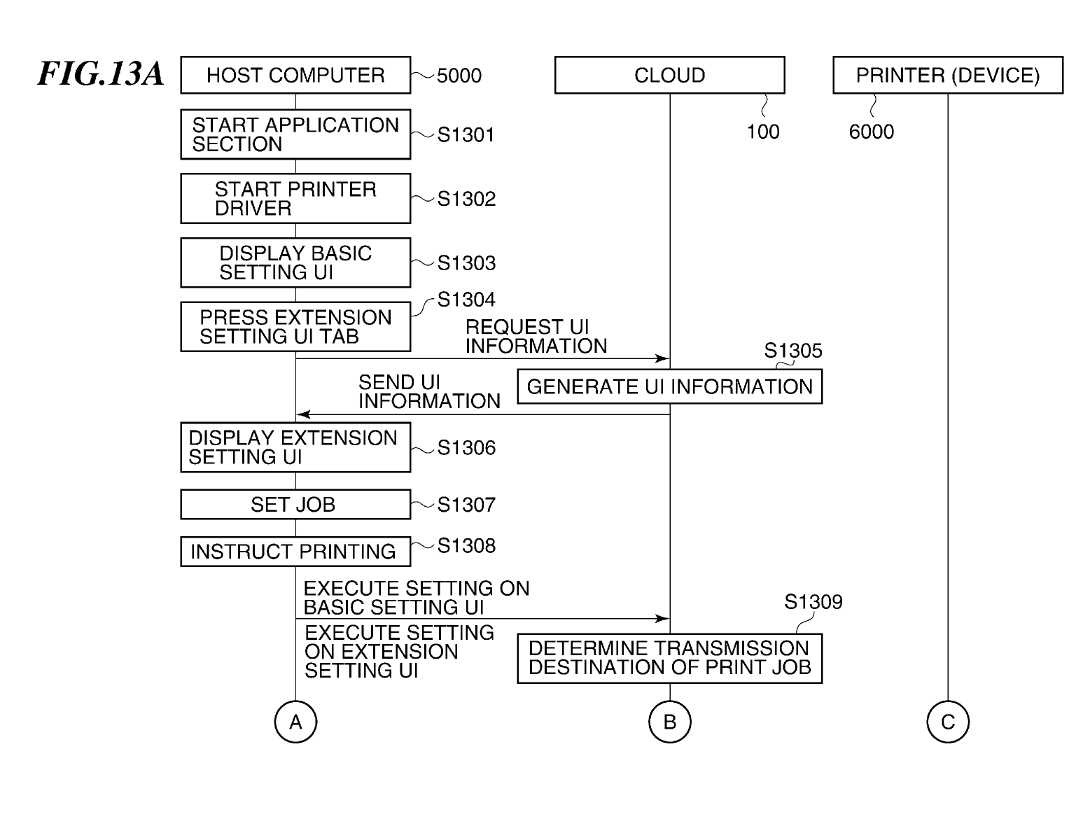

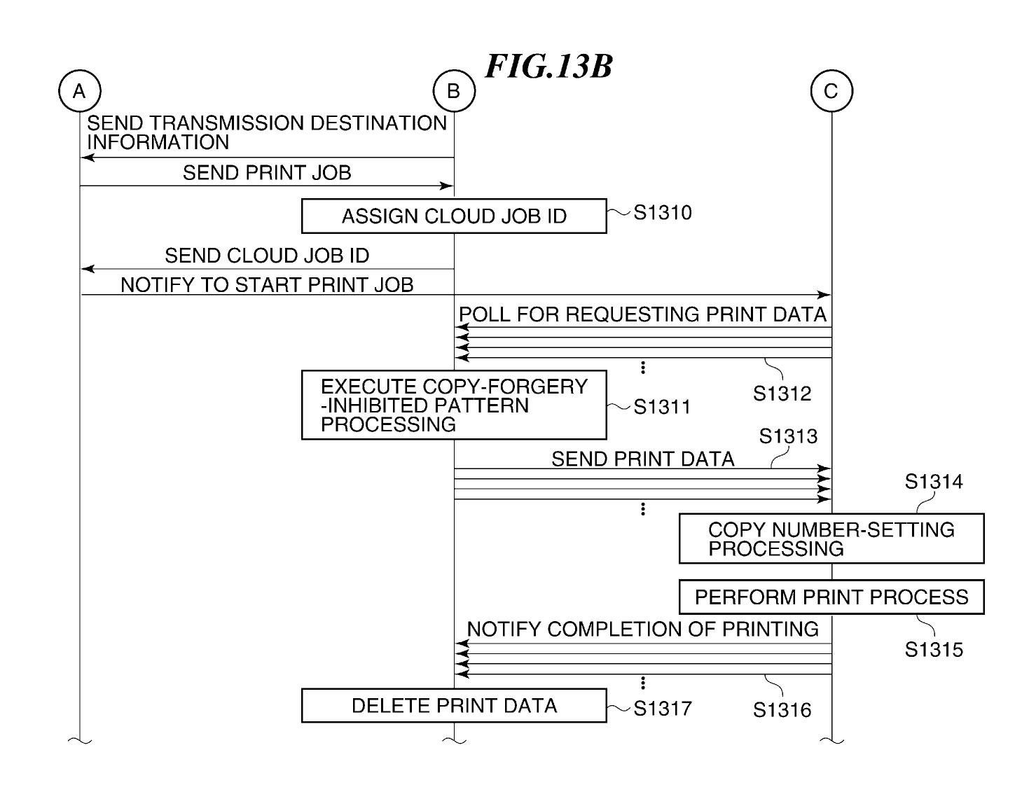

FIGS. 13A and 13B are a sequence diagram showing a flow of processing executed between the host computer 5000, the cloud 100, and the printer 6000 shown in FIG. 1. It should be noted that the following description is given of a case where the number of copies is set as a basic setting (basic print setting), and a copy-forgery-inhibited pattern is set as an extension setting (extension print setting).

Referring to FIGS. 3, 5, 13A, and 13B, in the host computer 5000, first, the application section 5010 is started (step S1301). Then, the user generates a document using the application section 5010. To perform printing, the printer driver 5020 is started (step S1302).

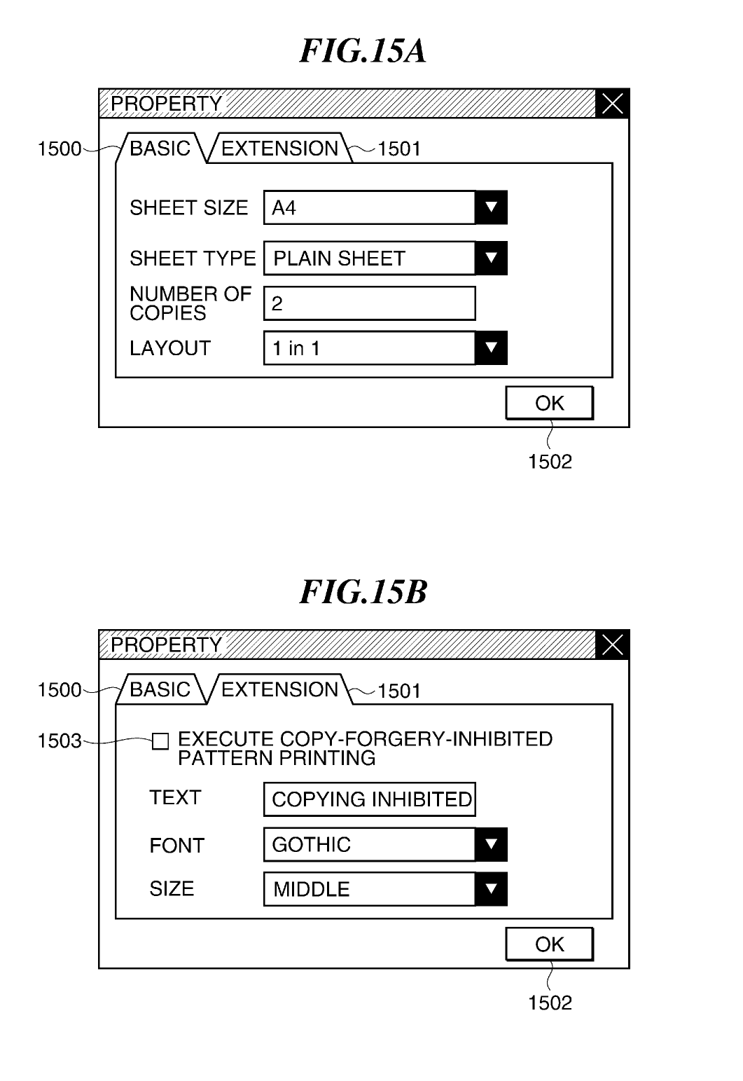

When the printer driver 5020 of the host computer 5000 is started, a basic setting user interface (a basic setting tab screen of the user interface; referred to hereinafter with reference to FIG. 15A) is displayed on the CRT 210 (basic setting user interface display: step S1303). To set a copy-forgery-inhibited pattern, an extension setting user interface tab is pressed (step S1304). This causes an extension setting user interface information request to be sent to the cloud 100. The extension setting user interface information request contains device information, referred to hereinafter. In response to the extension setting user interface information request, the cloud 100 checks the latest versions of functions usable by the printer 6000 that the host computer 5000 is about to use. Then, the cloud 100 generates the extension setting user interface information (user interface information generation: step S1305), and sends the same back to the host computer 5000.

The host computer 5000 generates an extension setting user interface based on the extension setting user interface information returned from the cloud 100, and displays an extension setting user interface (an extension tab screen of the user interface; referred to hereinafter with reference to FIG. 15B) on the CRT 210 (step S1306). Then, setting of the copy-forgery-inhibited pattern is executed on the extension setting user interface, as described hereinafter, and the number of copies is designated on the basic setting user interface (step S1307). Then, the host computer 5000 gives a print instruction (step S1308).

Next, the host computer 5000 sends print job setting information to the cloud 100. Then, as described hereinabove, the cloud 100 determines a transmission destination of the print job (step S1309), and sends the result of the determination back to the host computer 5000.

In the illustrated example, since the settings of the print job include the setting of the copy-forgery-inhibited pattern, in the result of the determination, the cloud 100 is the transmission destination. Therefore, the host computer 5000 sends the print job to the cloud 100.

It should be noted that if the copy-forgery-inhibited pattern processing is not set, the host computer 5000 directly sends the print job to the device, i.e. the printer 6000.

The cloud 100 assigns an cloud ID to the print job sent from the host computer 5000 (hereinafter the cloud ID assigned to the print job is also referred to as the “cloud job ID”) (step S1310). Then, the cloud 100 sends the cloud job ID to the host computer 5000. Upon receipt of the cloud job ID, the host computer 5000 notifies the printer 6000 to start printing. This notification for starting printing contains the cloud job ID.

The cloud 100 executes the copy-forgery-inhibited pattern processing on the received print job (step S1311). On the other hand, the printer 6000 polls the cloud 100 for requesting the print data therefrom, using the cloud job ID (step S1312).

In response to the polling from the printer 6000 for requesting the print data, the cloud 100 sends print data of each page having gone through the copy-forgery-inhibited pattern processing to the printer 6000 (step S1313). Upon acquisition of the print data from the cloud 100, the printer 6000 executes copy number-setting processing (step S1314), and then performs a print process (step S1315). Whenever printing of one page is completed, the printer 6000 notifies the cloud 100 of the completion of printing of the page (step S1316). Upon receipt of the notification, the cloud 100 deletes the print data of the corresponding page (step S1317).

As described above, the printer 6000 performs printing. Next, a description will be given of details of the above-described processes.

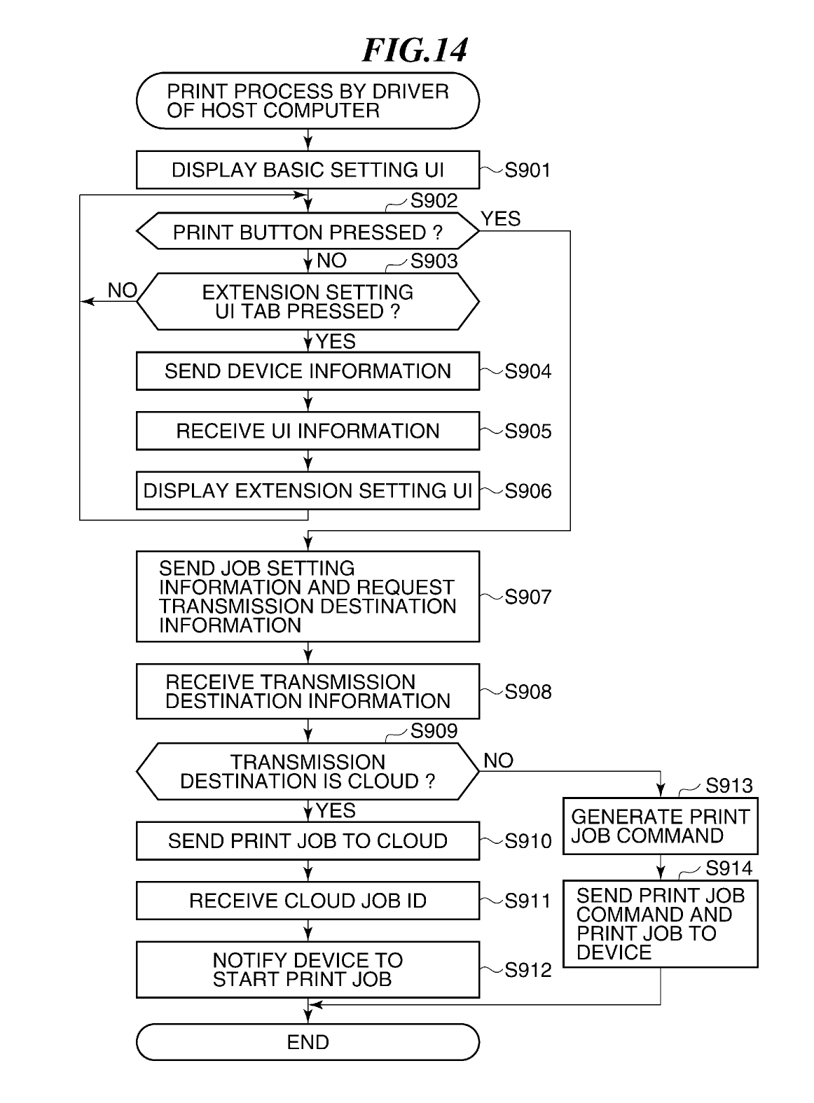

FIG. 14 is a flowchart of the print process executed by the printer driver 5020 of the host computer 5000 appearing in FIG. 5.

Referring to FIGS. 4, 5, and 14, now, when the printer driver 5020 is started on the CPU 201 of the host computer 5000, the CPU 201 displays the basic setting user interface on the CRT 210 (step S901). Then, the CPU 201 monitors whether or not an OK button (print button) has been pressed (step S902).

FIGS. 15A and 15B are diagrams showing the user interface displayed on the CRT 210 of the host computer 5000 appearing in FIG. 4. FIG. 15A shows the basic setting user interface (basic setting tab screen), while FIG. 15B shows an extension setting user interface (extension setting tab screen).

As shown in FIG. 15A, the basic setting user interface displays the title of property, and a basic setting user interface tab 1500 and an extension setting user interface tab 1501. Further, the basic setting user interface displays entry fields for a sheet size, a sheet type, the number of copies, and a layout, and an OK button 1502. The user configures basic settings e.g. for printing on the basic setting user interface.

More specifically, the user inputs a sheet size, a sheet type, the number of copies, and a layout as basic setting information from the basic setting user interface. When the user has pressed the OK button 1502 on the basic setting user interface after configuring the basic setting information (YES to the step S902), the CPU 201 of the host computer 5000 proceeds to a step S907, referred to hereinafter.

On the other hand, when the OK button 1502 has not been pressed (NO to the step S902), the CPU 201 of the host computer 5000 determines whether or not the extension setting user interface tab 1501 has been pressed (step S903). If the extension setting user interface tab 1501 has been pressed (YES to the step S903), the CPU 201 sends an extension setting user interface information request containing device information on the printer 6000 to the cloud 100 (step S904), and requests the cloud 100 to send. The device information includes the model and the device name of the device, for example.

If the extension setting user interface tab 1501 has not been pressed (NO to the step S903), the CPU 201 of the host computer 5000 returns to the step S903 to monitor whether or not the OK button (print button) 1502 has been pressed.

After the step S904, the CPU 201 of the host computer 5000 receives the extension setting user interface information from the cloud 100 as a response to the request for the extension setting user interface information (receive user interface information: step S905). Then, the CPU 201 displays the extension setting user interface (extension setting tab screen) shown in FIG. 15B on the CRT 210, according to the extension setting user interface information (step S906).

As shown in FIG. 15B, the extension setting user interface displays the title of property, and the basic setting user interface tab 1500 and the extension setting user interface tab 1501. Further, the extension setting user interface displays a check box 1503 for setting whether or not to execute copy-forgery-inhibited pattern printing, and entry fields for text, font, and size. Further, the extension setting user interface also displays the OK button 1502. Thus, the user configures extension settings concerning printing, for example, on the extension setting user interface.

That is, on the extension setting user interface, the user checks the check box 1503, and inputs text, font, and size, for configuring extension setting information.

After that, the CPU 201 of the host computer 5000 returns to the step S902, wherein the CPU 201 monitors whether or not the OK button 1502 has been pressed. If the OK button 1502 has been pressed on the extension setting user interface (YES to the step S902), the CPU 201 proceeds to the step S907, referred to hereinafter.

In the following description, the above-mentioned basic setting information and extension setting information are sometimes referred to as the “print job setting information”. In the step S907, the CPU 201 of the host computer 5000 sends the print job setting information and a transmission destination request for requesting transmission destination information, to the cloud 100. Then, the CPU 201 receives the transmission destination information from the cloud 100 as a response to the transmission destination request (step S908).

Subsequently, the CPU 201 of the host computer 5000 determines whether or not a transmission destination indicated by the transmission destination information is the cloud 100 (step S909). If the transmission destination is the cloud 100 (YES to the step S909), the CPU 201 sends a print job to the cloud 100 (step S910). Then, the CPU 201 receives a cloud job ID from the cloud 100 as a response to the transmission of the print job (step S911).

Upon receipt of the cloud job ID, the CPU 201 of the host computer 5000 notifies the printer (device) 6000 to start the print job (step S912), followed by terminating the print process by the printer driver 5020.

In notifying the printer 6000 to start the print job, the CPU 201 of the host computer 5000 sends the cloud job ID and the basic setting information to the printer 6000.

On the other hand, in the step S909, if the transmission destination is not the cloud 100 (NO to the step S909), the CPU 201 of the host computer 5000 generates a print job command according to the print job setting information (step S913). Then, the CPU 201 sends the print job command and the print job to the printer (device) 6000 (step S914), followed by terminating the print process by the printer driver 5020.

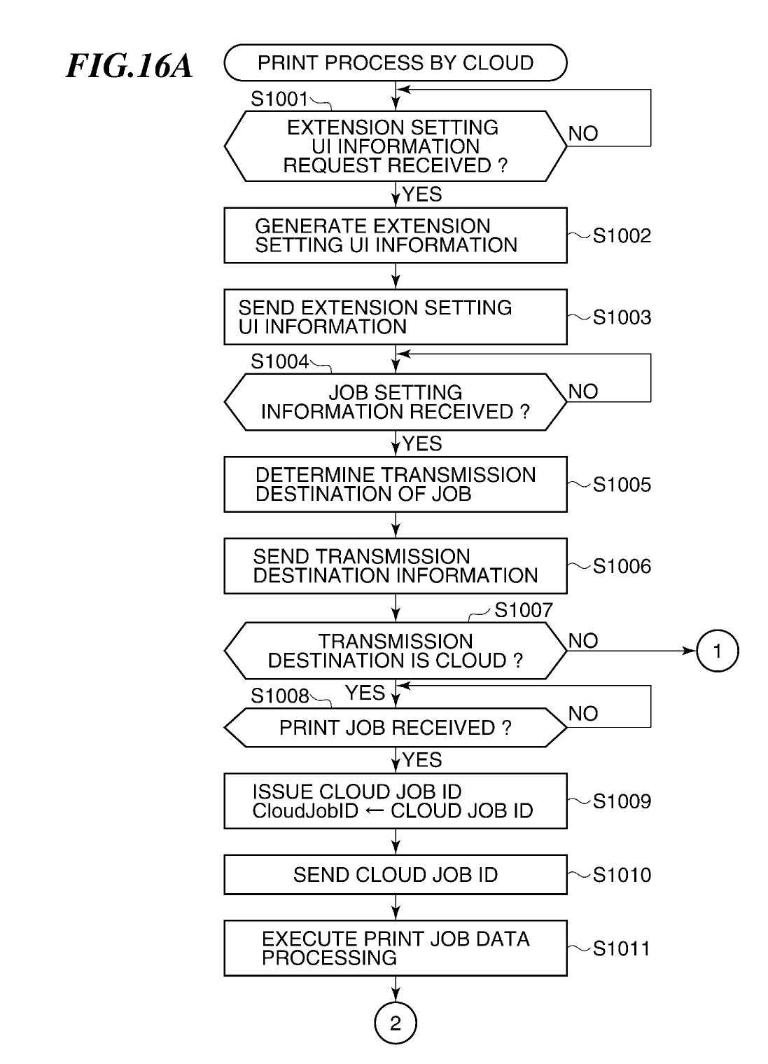

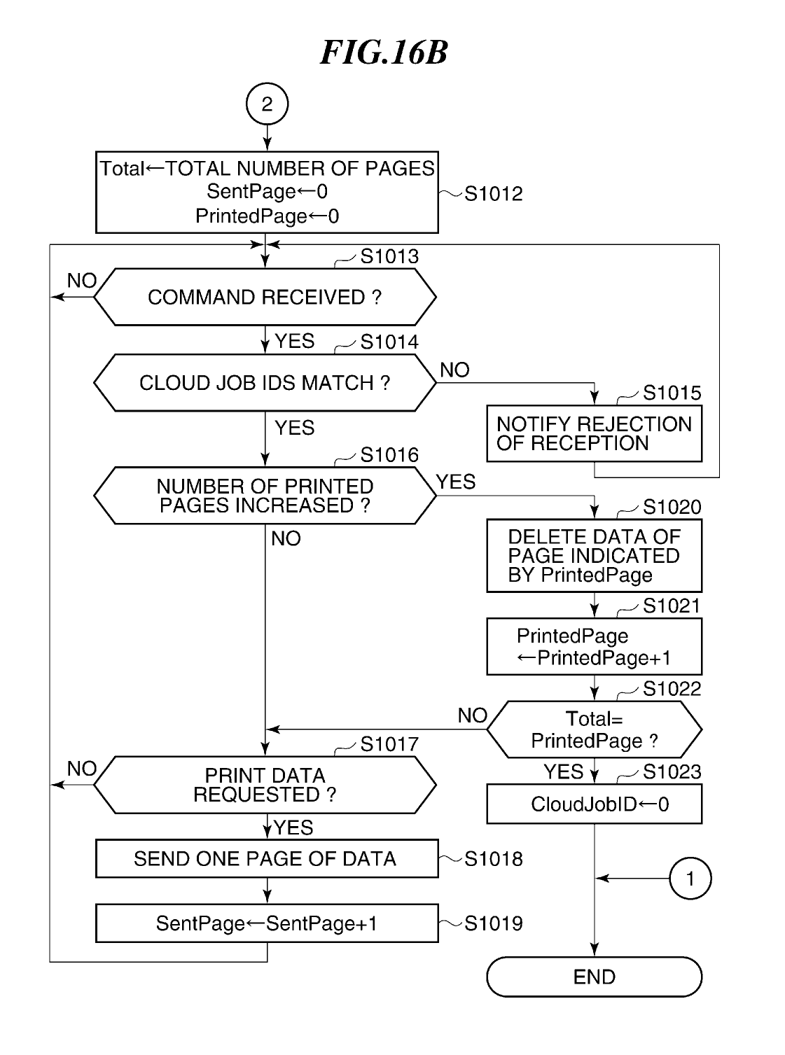

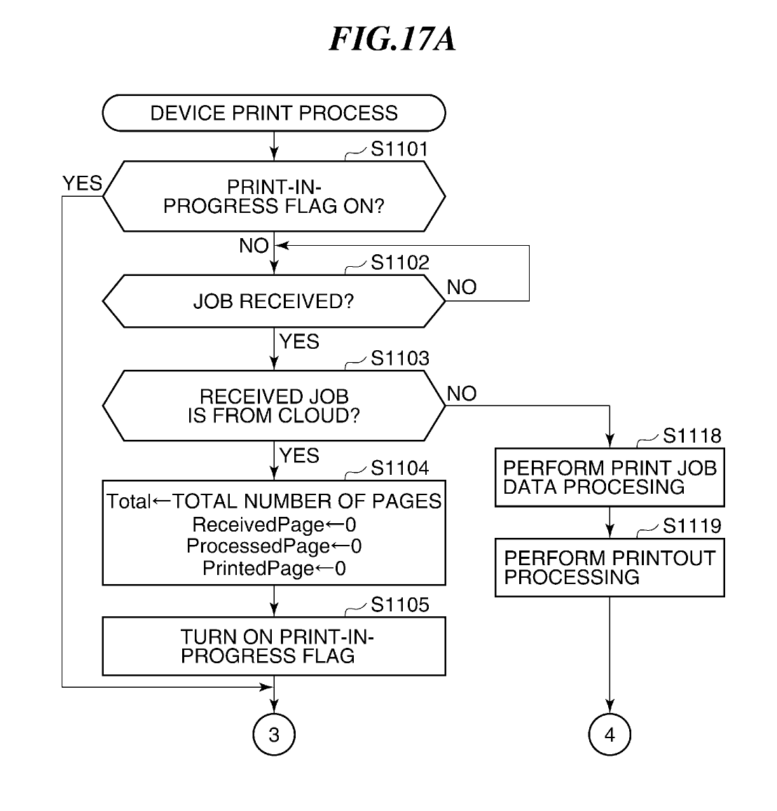

Next, a description will be given of a print process performed by the cloud 100 appearing in FIG. 1. FIGS. 16A and 16B are flowcharts of the print process performed by the cloud 100 appearing in FIG. 1.

Referring to FIGS. 3, 16A, and 16B, the following description will be given assuming that the directory server 1000 and the first and second processing servers 2000 and 3000 shown in FIG. 2 carry out the operation of the print process in cooperation with each other. The cloud 100 is provided with work areas for storing variables, such as “Total” for managing the total number of pages of a print job, “SentPage” indicative of the number of sent pages, “PrintedPage” indicative of the number of printed pages, and “CloudJobID” indicative a cloud job ID.

In the cloud 100, the job request-accepting section 102 determines whether or not an extension setting user interface information request has been received from the host computer 5000 (step S1001). If no extension setting user interface information request has been received (NO to the step S1001), the job request-accepting section 102 waits until it receives an extension setting user interface information request.

On the other hand, if an extension setting user interface information request has been received (YES to the step S1001), the extension setting user interface-generating section 105 of the cloud 100 generates the extension setting user interface information according to the model of a device set forth in the device information contained in the received extension setting user interface information request (see the step S903 in FIG. 14) and functions that are to be provided by the cloud (step S1002). Then, the communication section 101 of the cloud 100 sends the extension setting user interface information to the host computer 5000 (step S1003).

Then, the job request-accepting section 102 of the cloud 100 determines whether or not print job setting information has been received (step S1004). If the print job setting information has not been received (NO to the step S1004), the job request-accepting section 102 waits until it receives the print job setting information.

On the other hand, if the print job setting information has been received (YES to the step S1004), the transmission destination-determining section 106 of the cloud 100 determines a transmission destination of the print job based on the print job setting information (step S1005).

Here, in a case where the print job setting information includes settings made using the extension setting user interface, the transmission destination is determined to be the cloud 100. If the print job setting information includes no settings made using the extension setting user interface, the transmission destination is determined to be the printer 6000, and the communication section 101 of the cloud 100 sends transmission destination information indicative of the transmission destination back to the host computer 5000 (step S1006).

Subsequently, the transmission destination-determining section 106 of the cloud 100 determines whether or not the transmission destination indicated by the transmission destination information sent back in the step S1006 is the cloud 100 (step S1007). If the transmission destination is not the cloud 100 (NO to the step S1007), the print process by the cloud 100 is terminated.

If the transmission destination is the cloud 100 (YES to the step S1007), the job request-accepting section 102 of the cloud 100 determines whether or not the print job has been received (step S1008). If the print job has not been received (NO to the step S1008), the job request-accepting section 102 waits until it receives the print job.

If the print job has been received (YES to the step S1008), the job request-accepting section 102 assigns a cloud job ID to the received print job (step S1009). This cloud job ID is stored as “CloudJobID”.

Then, the communication section 101 sends the cloud job ID back to the host computer 5000 (step S1010). Next, an associated one of the job processing sections 103 performs the printing process according to the print job (step S1011), to generate print data. For example, when the print job setting information includes the setting of the copy-forgery-inhibited pattern, processing for adding the copy-forgery-inhibited pattern is executed.

Next, the job request-accepting section 102 stores the total number of pages as “Total” according to the print job setting information, and initializes both “SentPage” and “PrintedPage” to 0 (step S1012). Then, the job request-accepting section 102 determines whether or not a print job command has been received from the host computer 5000 (step S1013).

If no print job command has been received (NO to the step S1013), the job request-accepting section 102 waits until it receives a print job command. This print job command should includes the cloud job ID, the number of printed pages, and a print data request flag.

On the other hand, if the print job command has been received (YES to the step S1013), the job request-accepting section 102 determines whether or not the cloud job ID included in the print job command matches “CloudJobID” (step S1014). If the cloud job ID does not match “CloudJobID” (NO to the step S1014), the job request-accepting section 102 notifies the host computer 5000 that reception of the print job command has been rejected, via the communication section 101 (step S1015). Then, the job request-accepting section 102 returns to the step S1013.

If the cloud job ID included in the print job command matches “CloudJobID” (YES to the step S1014), the job request-accepting section 102 compares the number of printed pages with “PrintedPage” (step S1016) to determine whether or not the number of printed pages has become larger than the value stored before.

If the number of printed pages has not become larger than “PrintedPage” (NO to the step S1016), the job request-accepting section 102 determines whether or not the print data request flag included in the print job command is on (step S1017). If the print data request flag is not on (NO to the step S1017), the job request-accepting section 102 returns to the step S1013.

If the print data request flag is on (YES to the step S1017), the job request-accepting section 102 sends one page of the print data received from the job processing sections 103 to the printer 600 via the communication section 101 (step S1018). Next, the job request-accepting section 102 increments “SentPage” by 1 (step S1019), and then returns to the step S1013.

In the step S1016, if the number of printed pages has become larger than “PrintedPage” (YES to the step S1016), the job request-accepting section 102 deletes the print data of the page of which the printing has been completed (step S1020), and then increments “PrintedPage” by 1 (step S1021).

Subsequently, the job request-accepting section 102 determines whether or not “Total” and “PrintedPage” match each other (step S1022). If “Total” and “PrintedPage” do not match each other (NO to the step S1022), the job request-accepting section 102 proceeds to the step S1017.

On the other hand, if “Total” and “PrintedPage” match each other (YES to the step S1022), the job request-accepting section 102 resets “CloudJobID” to 0 (step S1923), followed by terminating the print process by the cloud 100.

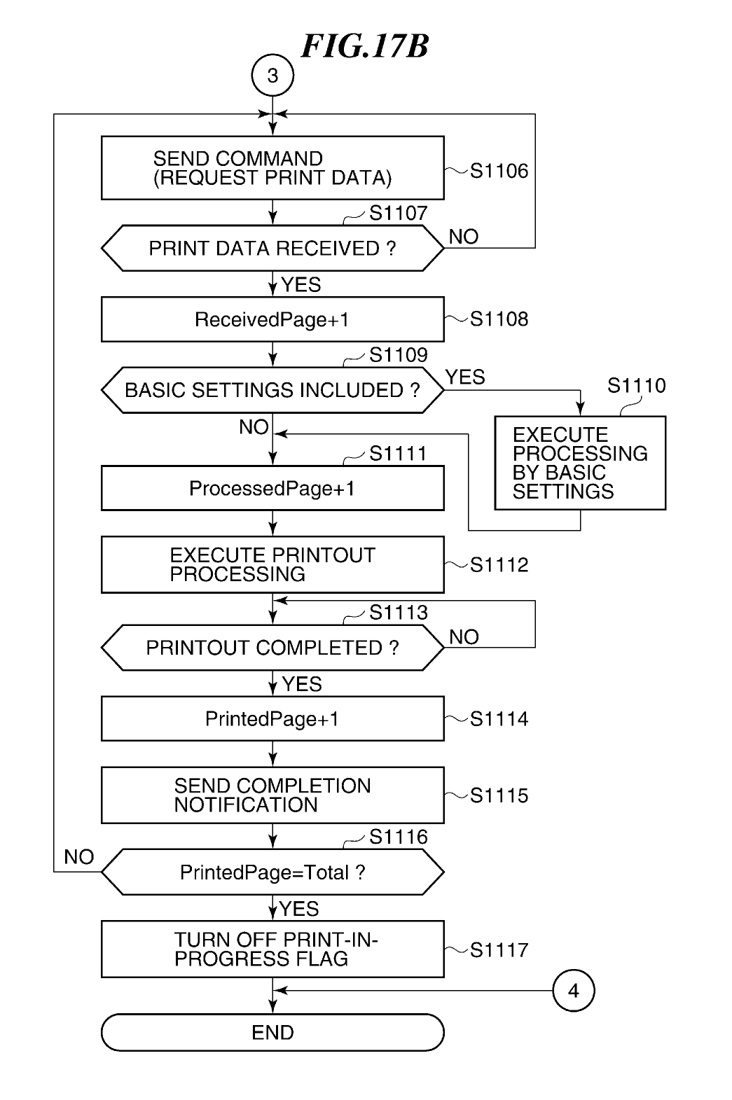

FIGS. 17A and 17B are flowcharts of a print process executed by the printer (device) 6000 appearing in FIG. 1.

Referring to FIGS. 4, 5, 17A, and 17B, as described hereinabove, the functions of the printer 6000 appearing in FIG. 5 operate on the CPU 312 appearing in FIG. 4. The printer 6000 is provided with work areas for storing variables, such as “Total” indicative of the total number of pages, “ReceivedPage” indicative of the number of received pages, and “ProcessedPage” indicative of the number of processed pages. Further, the printer 6000 is also provided with work areas for storing variables, such as “PrintedPage” indicative of the number of printed pages, and a print-in-progress flag indicating that there is a print job in progress.

When the printer 6000 is started, the CPU 312 determines whether or not there is a print job in progress (step S1101). Here, if the print-in-progress flag is on, the CPU 312 determines that there is a print job in progress. The use of the print-in-progress flag makes it possible, e.g. even when the power is turned off during the print process, to resume the print process from an intermediate part of the print job (specifically, the print data thereof) where the printing operation is interrupted.

If there is no print job in progress (NO to the step S1101), the CPU 312 of the printer 6000 determines whether or not a print job has been received from the host computer 5000 (step S1102). If no print job has been received (NO to the step S1102), the CPU 312 waits until it receives a print job.

On the other hand, if a print job has been received (YES to the step S1102), the CPU 312 determines whether or not the received print job is from the cloud 100 by determining whether or not information on the received print job contains a cloud job ID (step S1103).

If the received print job is from the cloud 100 (YES to the step S1103), the CPU 312 stores the total number of pages as “Total” according to the received print job (step S1104), and initializes “ReceivedPage”, “ProcessedPage”, and “PrintedPage” to 0. Further, the CPU 312 turns on the print-in-progress flag, thereby recording print-in-progress information indicating that a print job is in progress (step S1105).

Then, the CPU 312 turns on the print data request flag, and sends a print job command to the cloud 100 (step S1106). It should be noted that in the step S1101, if there is a print job in progress (YES to the step S1101), the CPU 312 directly proceeds to the step S1106.

Next, the CPU 312 determines whether or not print data has been received from the cloud 100 (step S1107). If no print data has been received from the cloud 100 (NO to the step S1107), the CPU 312 returns to the step S1106 to continue the process.

If print data has been received from the cloud 100 (YES to the step S1107), the CPU 312 increments “ReceivedPage” by 1 (step S1108), and then determines whether or not the print data includes settings made by the basic setting user interface, according to the print job setting information (step S1109).

If the print data includes the settings made by the basic setting user interface (YES to the step S1109), the CPU 312 executes processing set by the settings made via the basic setting user interface (step S1110). For example, if the number of copies is set to two by the settings made by the basic setting user interface, the CPU 312 performs processing for setting the number of pages to two. Then, the CPU 312 increments “ProcessedPage” (step S1111) by 1. If the print data does not include the settings made by the basic setting user interface in the step S1109 (NO to the step S1109), the process directly proceeds to the step S1111.

Next, the CPU 312 carries out the printout processing, as described hereinabove (step S1112). Then, the CPU 312 determines whether or not the printout (printing) performed according to the print job setting information has been completed (step S1113). If the printout has not been completed (NO to the step S1113), the CPU 312 waits until the printout is completed.

When the printout has been completed (YES to the step S1113), the CPU 312 increments “PrintedPage” by 1 (step S1114), and sends a printing completion notification to the cloud 100 (step S1115).

Then, the CPU 312 determines whether or not “PrintedPage” and “Total” match each other (step S1116). If “Total” and “PrintedPage” do not match each other (NO to the step S1116), the process returns to the step S1106.

On the other hand, if “PrintedPage” and “Total” match each other (YES to the step S1116), the CPU 312 determines that the printout of all the pages has been completed, and turns off the print-in-progress flag to thereby delete the print-in-progress information (step S1117), followed by terminating the print process.

In the above-mentioned step S1103, if the received print job is not from the cloud 100 (NO to the step S1103), the CPU 312 executes the print job according to the settings made by the basic setting user interface (step S1118). Then, the CPU 312 performs printout processing (step S1119), followed by terminating the print process.

As described above, according to the embodiment of the present invention, only when the settings by the extension setting user interface, which require the use of the cloud 100, are set, print data is prepared by making use of the cloud 100 and then the print data is sent to the printer 6000. On the other hand, when the settings made by the basic setting user interface, which do not require the use of the cloud 100, are set, a print job is directly sent from the host computer 5000 to the printer 6000. Therefore, if the present embodiment is employed, it is possible to perform printing efficiently by using the cloud 100 externally provided, as required, while reducing costs.

It should be noted that as is clear from the above description, in the host computer 5000, the CPU 201 functions as a reception unit, a transmission unit, a determination unit, and a notification unit.

Although a description has been given of the embodiment of the present invention, the present invention is by no means limited to the above-described embodiment, but it includes various forms insofar as they do not depart from the spirit and scope thereof.

For example, it is possible to selectively cause the host computer 5000, the cloud 100, and the printer 6000 to execute a print control method comprising steps of operations performed by the functions of the above-described embodiment.

Further, it is possible to selectively cause the host computer 5000, the cloud 100, and the printer 6000 to execute a computer-executable program for causing a computer to realize the functions of the above-described embodiment.

It is to be understood that the present invention may also be realized by supplying a system or an apparatus with a storage medium in which a program code of software, which realizes the functions of the above described embodiment is stored, and causing a computer (or CPU or MPU) of the system or apparatus to read out and execute the program code stored in the storage medium.

### REFERENCE SIGNS LIST

10 Internet
11 LAN
12 LAN
100 cloud
1000 directory server
2000, 3000 processing servers
5000 host computer
6000 printer

1. An information processing apparatus that is communicable with a server system including at least one server, and a printer, comprising:
an accepting unit configured to accept a single instruction which is input by a user, for instructing printing; and
a transmission unit configured to transmit a print job to the server system according to the single instruction accepted by said accepting unit, and at the same time transmit an instruction for acquiring print data from the server system, to the printer.

2. The information processing apparatus according to claim 1, wherein the print data is generated by the server system based on the print job.

3. The information processing apparatus according to claim 1, wherein the print job includes information on an image processing to be executed by the server system.

4. The information processing apparatus according to claim 1, wherein the instruction transmitted by said transmission unit includes an address of the server system.

5. The information processing apparatus according to claim 1, further comprising:
a determination unit configured to determine whether to transmit the print job to the server system or to the printer,
wherein if said determination unit determines to transmit the print job to the server system, said transmission unit transmits the print job to the server system, and at the same time transmits an instruction for acquiring the print data from the server system, to the printer, and
wherein if said determination unit determines to transmit the print job to the printer, said transmission unit transmits the print job to the printer.

6. The information processing apparatus according to claim 2, further comprising:
a notification unit configured to notify the server system of information on processing to be executed;
a reception unit configured to receive information indicative of a transmission destination of the print job from the server system; and
a determination unit configured to determine whether to transmit the print job to the server system or to the printer based on the information received by said reception unit.

7. The information processing apparatus according to claim 1, wherein the information processing apparatus is connected to the server system via the Internet, and is connected to the printer via a local area network.

8. A method of controlling an information processing apparatus that is communicable with a server system including at least one server, and a printer, comprising:
accepting a single instruction which is input by a user, for instructing printing; and
transmitting a print job to the server system according to the single instruction accepted by said accepting, and at the same time transmitting an instruction for acquiring print data from the server system, to the printer.

9. A computer-executable program for causing a computer to execute a method of controlling an information processing apparatus that is communicable with a server system including at least one server, and a printer,
wherein the method comprises:
accepting a single instruction which is input by a user, for instructing printing; and
transmitting a print job to the server system according to the single instruction accepted by said accepting, and at the same time transmitting an instruction for acquiring print data from the server system, to the printer.

10. A non-transitory computer-readable storage medium storing a computer-executable program according to claim 9.
